(19) United States
(12) Patent Application Publication
(10) Pub. No.: US 2019/0310640 A1
(43) Pub. Date: Oct. 10, 2019

(54) SYSTEM AND METHOD FOR TRACKING A MOVABLE BODY

(71) Applicant: FUJITSU LIMITED, Kawasaki-shi (JP)

(72) Inventor: SHINYA YOKOI, Kawasaki (JP)

(73) Assignee: FUJITSU LIMITED, Kawasaki-shi (JP)

(21) Appl. No.: 16/361,004

(22) Filed: Mar. 21, 2019

(30) Foreign Application Priority Data
Apr. 10, 2018 (JP) 2018-075762

(51) Int. Cl. G05D 1/00; H04W 4/46; H04W 4/02; H04W 4/029; B64D 47/08; B64C 39/02

(52) U.S. Cl. CPC G05D 1/0094; H04W 4/46; H04W 4/023; H04N 5/23206; B64D 47/08; B64C 39/024; H04W 4/029

(57) ABSTRACT

A non-transitory computer-readable recording medium storing therein a control program for causing a computer to execute for estimating a movement direction of a movable body based on motion information obtained from a motion sensor mounted on the movable body; and transmitting a signal specifying a movement direction of an unmanned mobile object to which an image capture device is mounted to the unmanned mobile object based on the estimated movement direction.

### CROSS-REFERENCE TO RELATED APPLICATION

This application is based upon and claims the benefit of priority of the prior Japanese Patent Application No. 2018-75762, filed on Apr. 10, 2018, the entire contents of which are incorporated herein by reference.

### FIELD

The embodiments discussed herein are related to device system and method for tracking a movable body or object, such as a moving vehicle.

### BACKGROUND

The capturing of images of a moving object with an unmanned aerial vehicle (so-called drone) has heretofore been done based on operation by a trained drone operator. Moreover, in recent years, there have been drones that perform autonomous flying using designated GPS coordinates and techniques related to autonomous tracking using autonomous recognition techniques for drones such as image recognition and beacon tracking.

As related techniques, there are techniques involving correcting GPS location information on a moving object.

Related techniques are disclosed in, for example, Japanese Laid-open Patent Publication Nos. 2010-66073, 2005-331257, and 8-68651.

### SUMMARY

According to an aspect of the embodiments, a non-transitory computer-readable recording medium storing therein a control program for causing a computer to execute for estimating a movement direction of a movable body based on motion information obtained from a motion sensor mounted on the movable body; and transmitting a signal specifying a movement direction of an unmanned mobile object to which an image capture device is mounted to the unmanned mobile object based on the estimated movement direction.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example system configuration of an image capture control system;

FIG. 2 is an explanatory diagram illustrating an example hardware configuration of a sensor;

FIG. 3 is a flowchart illustrating an example procedure of a process of obtaining location information by the sensor;

FIG. 4 is an explanatory diagram illustrating an example format of GPS values;

FIG. 5 is a flowchart illustrating an example procedure of a process of obtaining motion information;

FIG. 6 is an explanatory diagram illustrating an example format for a nine-axis sensor;

FIG. 7 is an explanatory diagram illustrating the content of pitch angle calculation;

FIG. 8 is an explanatory diagram illustrating the content of roll angle calculation;

FIG. 9 is an explanatory diagram illustrating the content of yaw angle calculation;

FIG. 10 is a block diagram illustrating an example hardware configuration of a server;

FIG. 11 is a block diagram illustrating an example hardware configuration of an unmanned mobile object;

FIG. 12 is a block diagram illustrating an example hardware configuration of each terminal device;

FIG. 13 is a block diagram illustrating an example functional configuration of the server;

FIG. 14 is a block diagram illustrating an example functional configuration of the unmanned mobile object;

FIG. 15 is a block diagram illustrating an example functional configuration of each terminal device;

FIG. 16 is a flowchart illustrating an example procedure of a process by the server;

FIG. 17 is a flowchart illustrating another example procedure of the process by the server;

FIG. 18 is a flowchart illustrating an example procedure of a process by the unmanned mobile object;

FIG. 19 is a flowchart illustrating an example procedure of a process by each terminal device;

FIG. 20 is an explanatory diagram illustrating an example of display windows on a terminal device;

FIG. 21 is an explanatory diagram illustrating another example of the display windows on the terminal device;

FIG. 22 is an explanatory diagram illustrating an overview of control of the unmanned mobile object; and

FIG. 23 is an explanatory diagram illustrating another example of a display window on the terminal device.

### DESCRIPTION OF EMBODIMENTS

Operating a drone, for example, requires a great deal of effort for the operator. Also, autonomous tracking techniques have a problem with moving objects that move at high speed, such as sailboards, because GPS information sent from such a moving object changing its location from moment to moment has a lag in terms of communication time or the like, so that the coordinates to capture an image of is offset.

Hereinafter, an embodiment of a control program, a control method, and a control device will be described in detail with reference to the drawings.

### EMBODIMENT

### Example System Configuration of Image Capture Control System 100

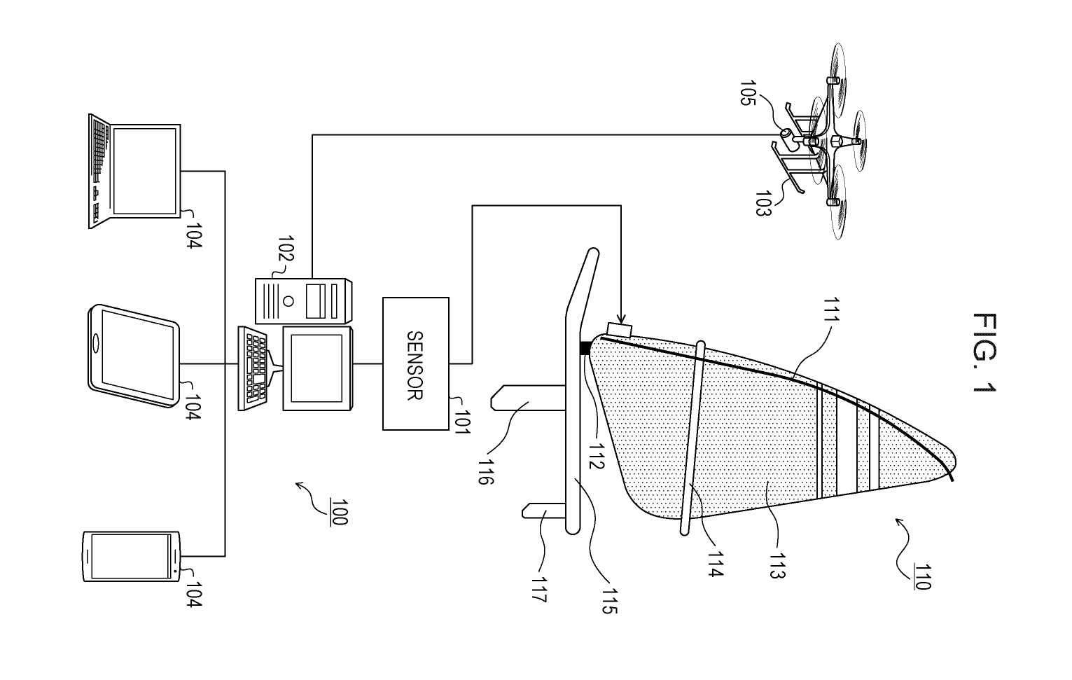

FIG. 1 is an explanatory diagram illustrating an example system configuration of an image capture control system. In FIG. 1, an image capture control system 100 is constituted of a sensor 101, a server 102, an unmanned mobile object 103, and terminal devices 104.

In FIG. 1, a windsurfing board 110 is illustrated as an example sailboard, which is a moving object that moves using lift from wind. “Rig” is a collective term for a mast, a sail, a boom, and a joint. The windsurfing board 110 is a special tool including a board part 115 and a rig mounted thereto and is operated by an operator to move on a water surface (hereinafter, this special tool will also be referred to as “sailboard 110” or “windsurfing board 110”).

The rig includes a mast 111, a joint 112, a sail 113, and a boom 114, and the rig is attached to the board part 115 by the joint 112. The board part 115 includes a daggerboard 116 and a fin 117.

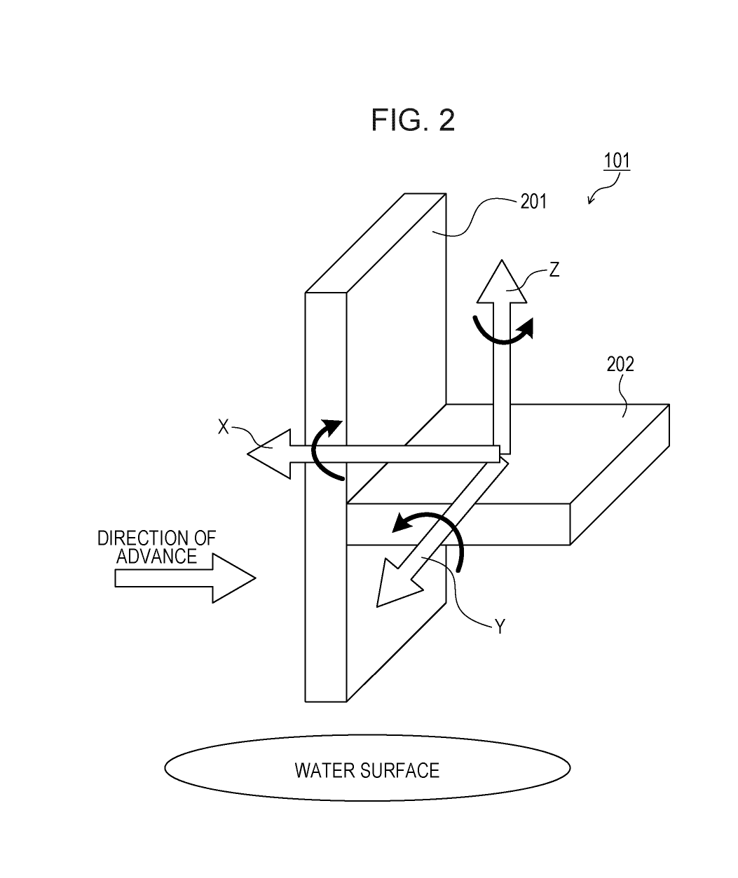

The sensor 101 is attached to a lower portion of the mast 111 near the joint 112. Details including the attachment of the sensor 101 to the mast 111 will be described later with reference to FIG. 2 and other figures.

In the image capture control system 100, the sensor 101 and the server 102 are connected via wireless communication. Alternatively, the sensor 101 and the server 102 may be configured to be connected through a wireless network not illustrated (such as the Internet).

In the image capture control system 100, the server 102 and the unmanned mobile object 103 are connected by wireless communication. Alternatively, the server 102 and the unmanned mobile object 103 may be configured to be connected through a wireless network not illustrated (such as the Internet).

In the image capture control system 100, the server 102 and each terminal device 104 are connected through a wired or wireless network not illustrated. The network may be, for example, the Internet, a mobile communication network, a local area network (LAN), a wide area network (WAN), or the like. The terminal device 104 may be equipped with the function of the server 102.

The sensor 101 obtains positioning information on the location of the windsurfing board 110 and information on the state of the sail 113. The server 102 obtains the pieces of information obtained by the sensor 101 from the sensor 101. The terminal device 104 displays various pieces of information transmitted from the server 102. These pieces of information include captured image information (such as a video) captured by the unmanned mobile object 103 and distributed by the server 102.

The server 102 is a server computer that controls the entire image capture control system 100. The server 102 may be implemented by a cloud server connected to a network or the like.

The unmanned mobile object 103 is a mobile object (for example, an airplane, rotorcraft, sailplane, airship, or the like) capable of unmanned travel by using remote operation or autonomous control. An image capture device 105 is mounted to the unmanned mobile object 103. The image capture device 105 may include an image sensor for capturing an image. Besides such an unmanned aerial vehicle (drone), the unmanned mobile object may be specifically an unmanned watercraft or the like, for example.

Each terminal device 104 is a computer to be used by a user of this image capture control system 100. Specifically, the terminal device 104 may be implemented by a personal computer, a tablet terminal device, a smartphone, or the like, for example. The terminal device 104 may be worn on the rider's body. Specifically, the terminal device 104 may be a wearable information processing device such as a wristwatch display device or a goggle display device, for example.

### Description of Sensor 101

FIG. 2 is an explanatory diagram illustrating an example hardware configuration of the sensor. In FIG. 2, the sensor 101 is constituted of a circuit board 201 and a nine-axis sensor 202 (specifically, a nine-axis inertial measurement unit, for example).

The nine-axis sensor 202 is provided on the circuit board 201, which is attached to the mast 111, so as to perpendicularly face the water surface and extend in parallel to the direction of advance. The circuit board 201 includes a GPS reception circuit. The sensor 101 simultaneously records GPS (data indicating the state of travel: the speed and the direction of advance) and the nine-axis sensor 202 (data indicating how the windsurfing board 110 is rode: three-dimensional sail operation). The sail operation (tilt of the mast 111 in the front-rear direction and the right-left direction and rotation of the mast 111) is recorded by detecting the rotation angle of the nine-axis sensor 202 about each of X, Y, and Z directions.

The nine-axis sensor 202 may be attached to the mast 111 of the rig or to the boom 114 of the rig. In particular, in the case where the mast 111 is fixed such as in a yacht, for example, the nine-axis sensor 202 is attached preferably to the boom 114, which is movable, rather than to the mast 111. Nevertheless, the nine-axis sensor 202 may be attached to a position other than the mast 111 of the rig and the boom 114 of the rig as long as it is capable of obtaining motion information on the sailboard.

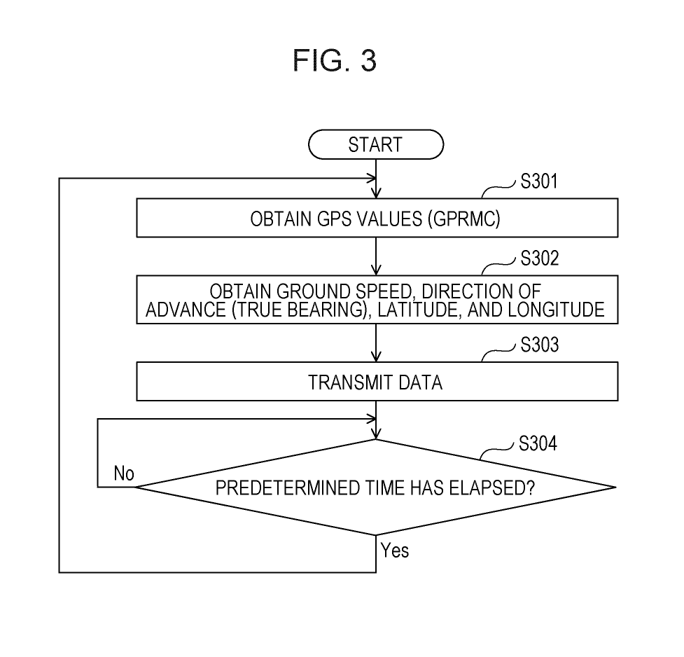

FIG. 3 is a flowchart illustrating an example procedure of a process of obtaining location information by the sensor. In the flowchart of FIG. 3, the sensor 101 obtains GPS values (GPRMC) indicating the current location (step S301). Then, from the GPS values obtained in step S301, the sensor 101 obtains data on the ground speed, the direction of advance (true bearing), the latitude, and the longitude (step S302).

Then, the sensor 101 transmits the obtained data to the server 102 (step S303). Then, the sensor 101 determines whether a predetermined time (specifically, one second, for example) has elapsed (step S304). The sensor 101 waits for the predetermined time to elapse (step S304: No), and returns to step S301 upon the elapse of the predetermined time (step S304: Yes). The sensor 101 continuously repeats this series of processes. As a result, the server 102 obtains data on the ground speed, the direction of advance (true bearing), the latitude, and the longitude (location information) from the sensor 101 at intervals of the predetermined time (one second, for example).

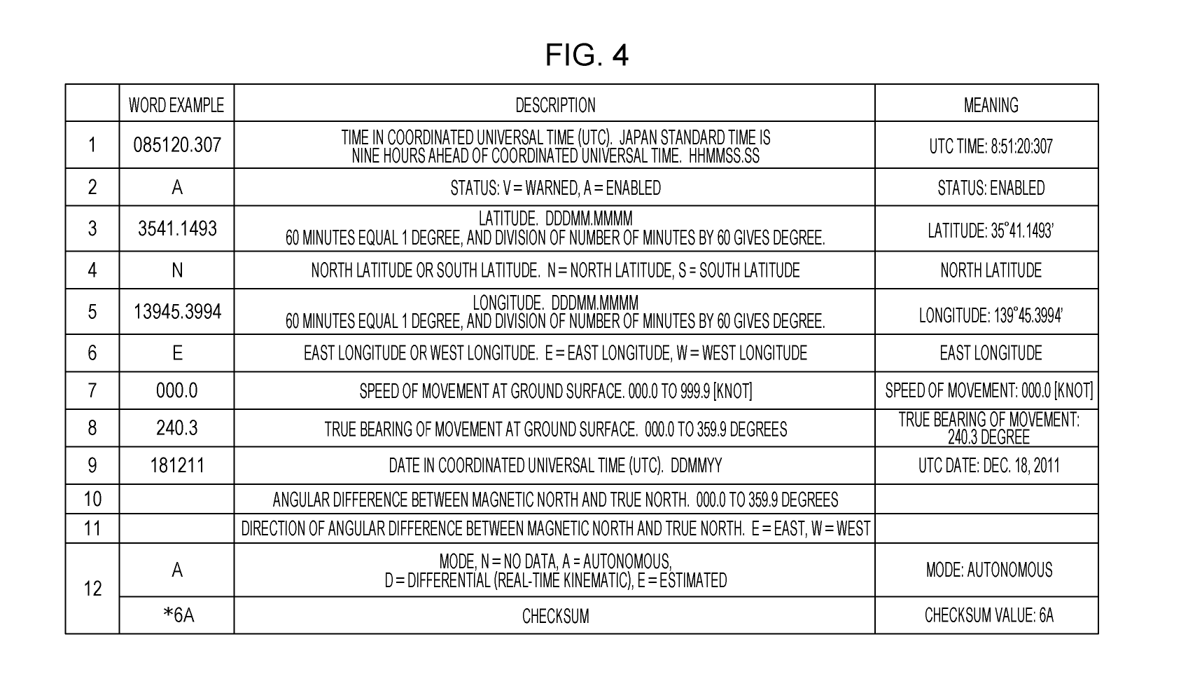

FIG. 4 is an explanatory diagram illustrating an example format of the GPS values. In the format illustrated in FIG. 4, an item 7 indicates the ground speed, an item 8 indicates the true bearing, items 3 and 4 indicate the latitude, and items 5 and 6 indicate the longitude.

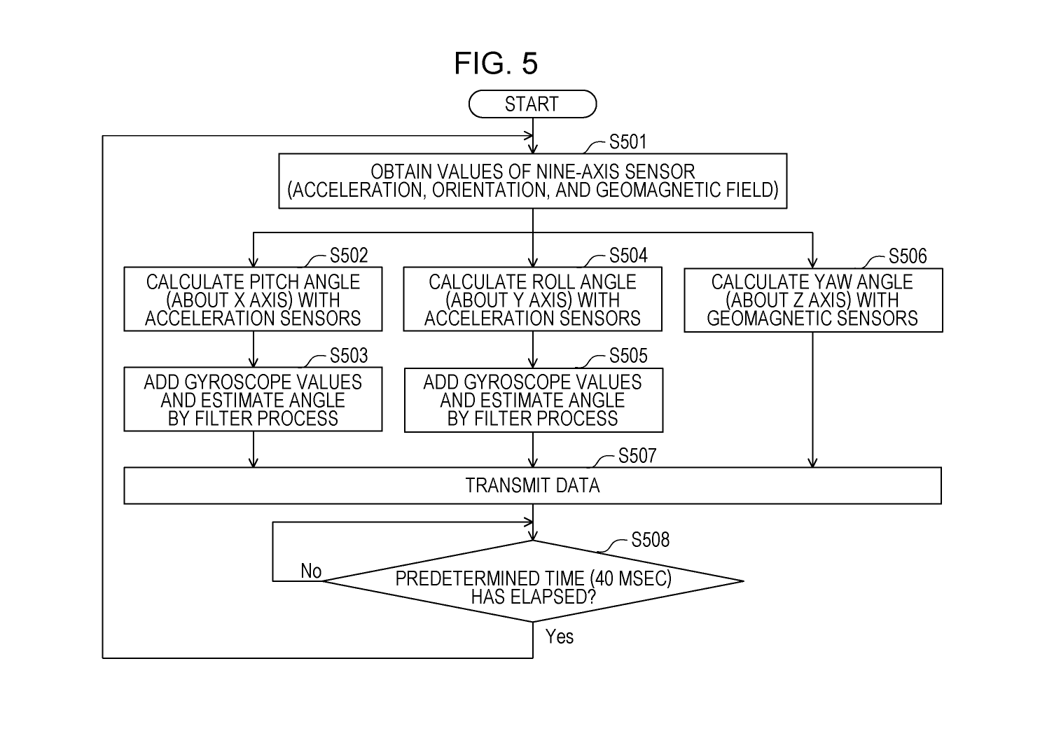

FIG. 5 is a flowchart illustrating an example procedure of a process of obtaining the motion information. In the flowchart of FIG. 5, the sensor 101 obtains the values of the nine-axis sensor 202 (step S501). Specifically, the sensor 101 obtains values measured by acceleration sensors, gyro sensors, and geomagnetic sensors as log data.

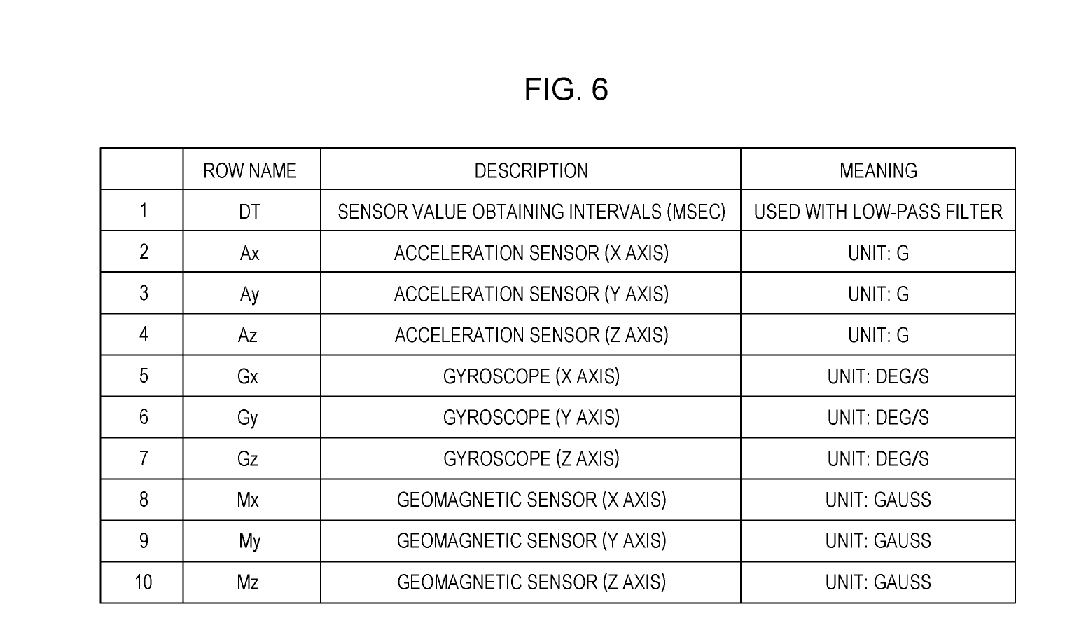

FIG. 6 is an explanatory diagram illustrating an example format for the nine-axis sensor. In FIG. 6, Ax, Ay, and Az represent an acceleration sensor (X axis), an acceleration sensor (Y axis), and an acceleration sensor (Z axis), respectively. Gx, Gy, and Gz represent a gyroscope (X axis), a gyroscope (Y axis), and a gyroscope (Z axis), respectively. Mx, My, and Mz represent a geomagnetic sensor (X axis), a geomagnetic sensor (Y axis), and a geomagnetic sensor (Z axis), respectively.

Among the obtained values of the nine-axis sensor 202, the sensor 101 calculates the pitch angle, or the angle about the X axis, with the acceleration sensors (step S502).

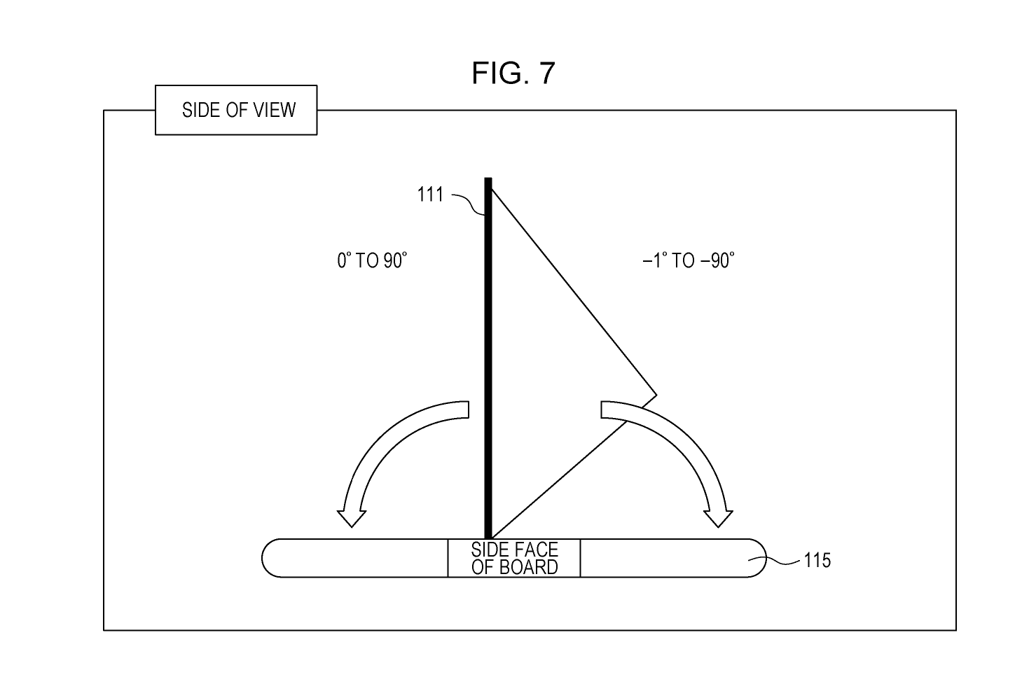

FIG. 7 is an explanatory diagram illustrating the content of the pitch angle calculation. FIG. 7 illustrates a view of the windsurfing board 110 as seen from the side (Side of View). In FIG. 7, the pitch angle (Euler angles) is 0° in a state where the mast 111 is perpendicular to the board part 115, and the pitch angle is positive (1° to 90°) in a state where the mast 111 is leaned forward, that is, tilted toward the nose, from the perpendicular state while the pitch angle is negative (−1° to −90°) in a state where the mast 111 is leaned rearward, that is, tilted toward the tail, from the perpendicular state. The pitch angle may be calculated within the above range.

The pitch angle may be calculated by equation (1).

Pitch angle=ATAN((ax)/SQRT(ay*+az*az)) (1)

ax: the value of the X-axis acceleration sensor

ay: the value of the Y-axis acceleration sensor

az: the value of the Z-axis acceleration sensor

Among the obtained values of the nine-axis sensor 202, the sensor 101 adds the gyroscope values of the gyro sensors and estimates the angle using a filter process (step S503). The filter process performed is, for example, a process such as a complementary filter, a linear Kalman filter, or an unscented Kalman filter. The pitch angle is obtained in this manner.

Among the values of the nine-axis sensor 202 obtained in step S501 in the flowchart of FIG. 5, the sensor 101 calculates the roll angle, or the angle about the Y axis, with the acceleration sensors (step S504). Among the obtained values of the nine-axis sensor 202, the sensor 101 adds the gyroscope values of the gyro sensors and estimates the angle using a filter process (step S505).

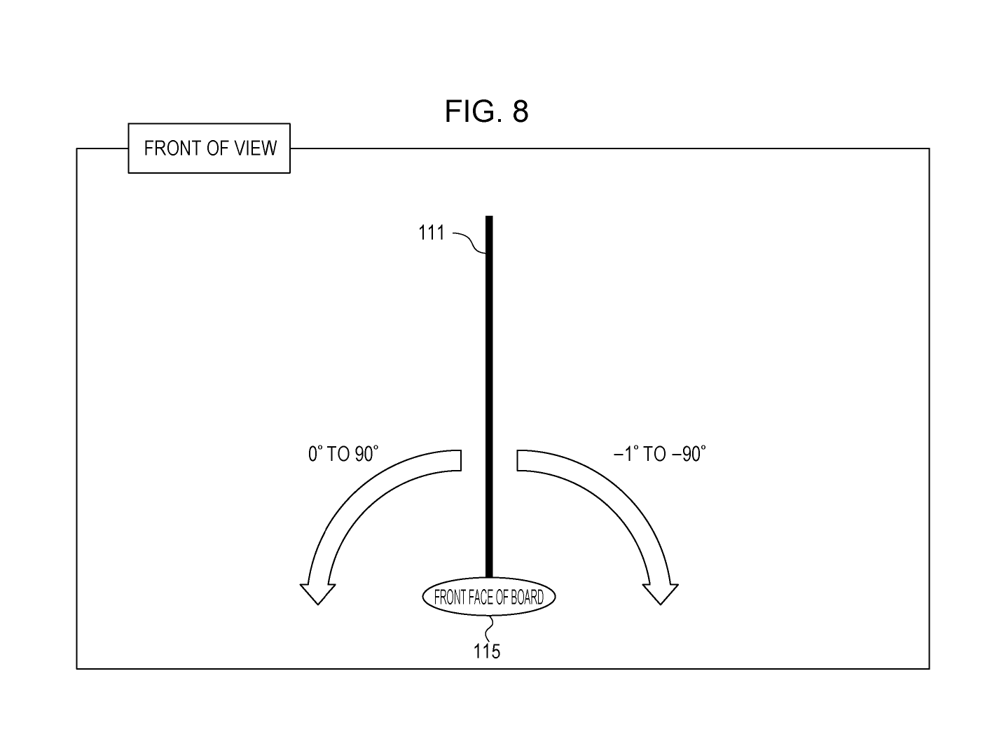

FIG. 8 is an explanatory diagram illustrating the content of the roll angle calculation. FIG. 8 illustrates a view of the windsurfing board 110 as seen from the front (Front of View). In FIG. 8, the roll angle (Euler angles) is 0° in the state where the mast 111 is perpendicular to the board part 115, and the roll angle is positive (1° to 90°) in a state where the mast 111 is leaned toward the left side in the diagram, that is, tilted toward the right side of the board part 115, from the perpendicular state while the roll angle is negative (−1° to −90°) in a state where the mast 111 is leaned toward the right side in the diagram, that is, tilted toward the left side of the board part 115, from the perpendicular state. The roll angle may be calculated within the above range.

The roll angle may be calculated by equation (2).

Roll angle=ATAN((ay)/SQRT(ax*ax+az*az)) (2)

The filter process performed is, for example, a process such as a complementary filter, a linear Kalman filter, or an unscented Kalman filter, similarly to the filter process used in the roll angle estimation. The roll angle is obtained in this manner.

Among the values of the nine-axis sensor 202 obtained in step S501 in the flowchart of FIG. 5, the sensor 101 calculates the yaw angle, or the angle about the Z axis, with the geomagnetic sensors (step S506).

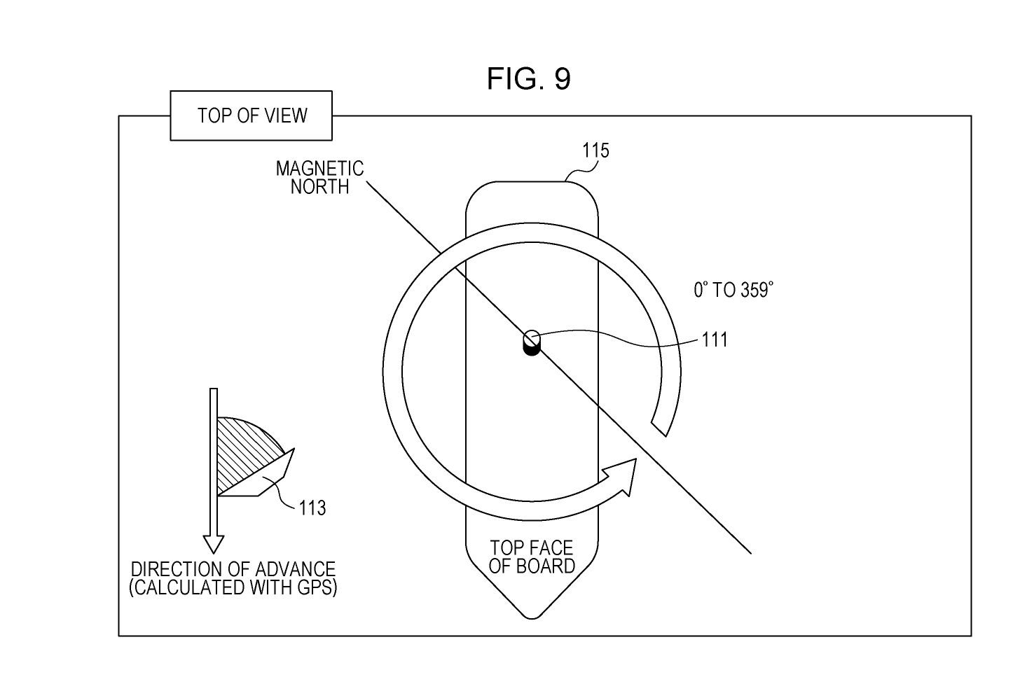

FIG. 9 is an explanatory diagram illustrating the content of the yaw angle calculation. FIG. 9 illustrates a view of the windsurfing board 110 as seen from above (Top of View). In FIG. 9, the yaw angle (Euler angles) is the rotation angle of the sail 113 about the mast 111 based on magnetic north. The yaw angle is 0° when the sail 113 is in a position in which its mast 111 side points to magnetic north, that is, in a position in which its boom end side points in the opposite direction from magnetic north. The yaw angle may be calculated within the range of 0° to 359° in the counterclockwise direction.

Since the direction of advance has already been calculated with the GPS, the rotation angle of the sail 113 may be calculated via orientation correction using a low-pass filter process based on the values of geomagnetic sensors.

The yaw angle (Yaw) may be calculated by equations (3) to (5).

magX: the value of the X-axis geomagnetic sensor

magY: the value of the Y-axis geomagnetic sensor

Yaw=atan2(magX,magY);

if (Yaw<0) Yaw+=2*PI;

if (Yaw≥2*PI) Yaw−=2*PI; (3)

Yaw=Yaw*180/M_PI; (4)

//The magnetic declination is adjusted under assumption of westerly declination (Japan)

Yaw=Yaw+6.6; //magnetic declination of 6.6 degrees

if (Yaw>360.0) Yaw=Yaw−360.0; (5)

The yaw angle is obtained in this manner.

The sensor 101 transmits data on the pitch angle obtained in steps S502 and S503, the roll angle obtained in steps S504 and S505, and the yaw angle obtained in step S506 (motion information) to the server 102 (step S507).

The sensor 101 determines whether a predetermined time (specifically, 40 milliseconds, for example) has elapsed (step S508). The sensor 101 waits for the predetermined time to elapse (step S508: No), and returns to step S501 upon the elapse of the predetermined time (step S508: Yes). The sensor 101 continuously repeats this series of processes. As a result, the server 102 obtains data on the pitch angle, the roll angle, and the yaw angle (motion information) from the sensor 101 at intervals of the predetermined time.

### Example Hardware Configuration of Server 102

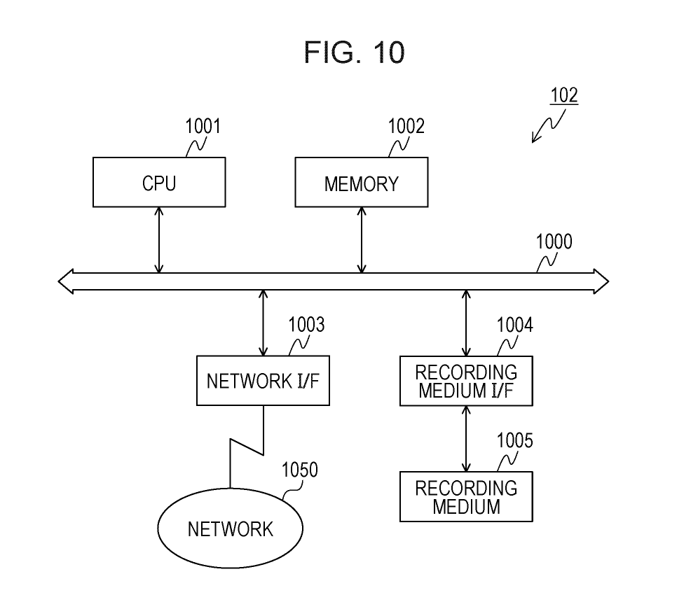

FIG. 10 is a block diagram illustrating an example hardware configuration of the server. In FIG. 10, the server 102 includes a CPU 1001, a memory 1002, a network interface (I/F) 1003, a recording medium I/F 1004, and a recording medium 1005. The components 1001 to 1004 are connected to each other by a bus 1000. The CPU 1001 may be a single CPU, multiple CPUs or multi-core CPUs.

The CPU 1001 has control over the entire server 102. The memory 1002 includes, for example, a read only memory (ROM), a random access memory (RAM), and a flash ROM or the like. Specifically, the flash ROM and the ROM store various programs, and the RAM is used as a work area for the CPU 1001. By being loaded to the CPU 1001, each program stored in the memory 1002 may cause the CPU 1001 to execute the corresponding coded process.

The network I/F 1003 is connected to a network 1050 through a communication line and connected to other devices (for example, other severs, the sensor 101, the unmanned mobile object 103, the terminal devices 104, and so on) through the network 1050. The network I/F 1003 serves as an interface between the network 1050 and the inside of the server and controls input and output of data from and to other devices. A modem, a LAN adaptor, or the like may be employed as the network I/F 1003, for example.

The recording medium I/F 1004 controls read and write of data from and to the recording medium 1005 under control of the CPU 1001. The recording medium 1005 stores data written thereto under control of the recording medium I/F 1004. The recording medium 1005 is, for example, a magnetic disk, an optical disk, an IC memory, or the like.

In addition to the above components 1001 to 1005, the server 102 may include, for example, a solid state drive (SSD), a keyboard, a pointing device, a display, and so on not illustrated.

### Example Hardware Configuration of Unmanned mobile object 103

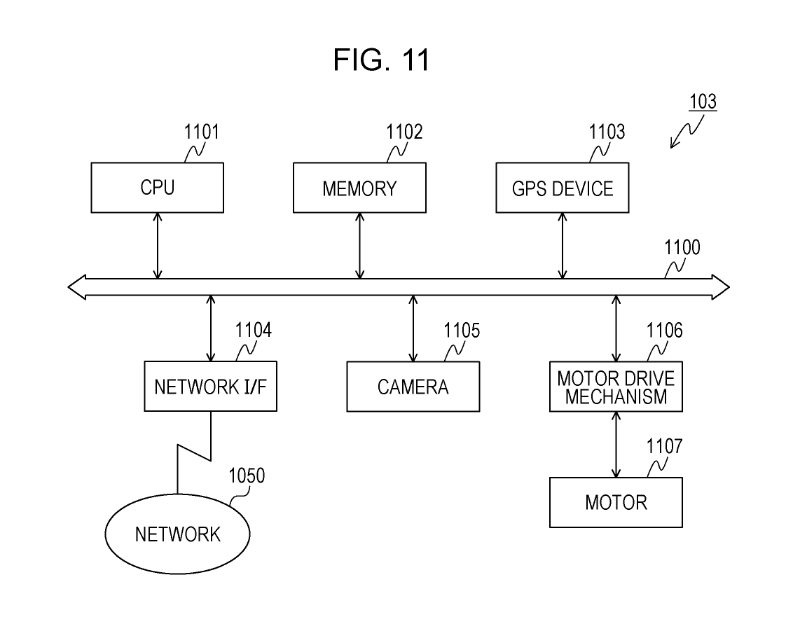

FIG. 11 is a block diagram illustrating an example hardware configuration of the unmanned mobile object. In FIG. 11, the unmanned mobile object 103 includes a CPU 1101, a memory 1102, a GPS device 1103, a network I/F 1104, a camera 1105, a motor drive mechanism 1106, and motors 1107. The components 1101 to 1106 are connected to each other by a bus 1100.

The CPU 1101 has control over the entire unmanned mobile object 103. The memory 1102 includes, for example, a ROM, a RAM, and a flash ROM or the like. Specifically, the flash ROM and the ROM store various programs, and the RAM is used as a work area for the CPU 1101. By being loaded to the CPU 1101, each program stored in the memory 1102 may cause the CPU 1101 to execute the corresponding coded process.

The GPS device 1103 includes a GPS reception circuit, receives radio waves from a plurality of GPS satellites, and calculates the current time, the current location, and so on based on the received radio waves.

The network I/F 1104 is connected to the network 1050, such as the Internet, through a communication line and connected to another device such as the server 102 through the network 1050. The network I/F 1104 serves as an interface between the network 1050 and the inside of the unmanned mobile object, and controls input and output of data from and to the other device.

The camera 1105 captures moving and still images. The camera 1105 may further be equipped with a zoom function and so on.

The motor drive mechanism 1106 controls the rotational drive of the motors 1107. The unmanned mobile object 103 is capable of ascending and descending and moving by adjusting each of the numbers of rotations of the plurality of motors 1107. Besides a motor(s) for moving the unmanned mobile object 103, some of the motors 1107 may be a motor(s) for changing the angle of the camera 1105.

### Example Hardware Configuration of Terminal Device 104

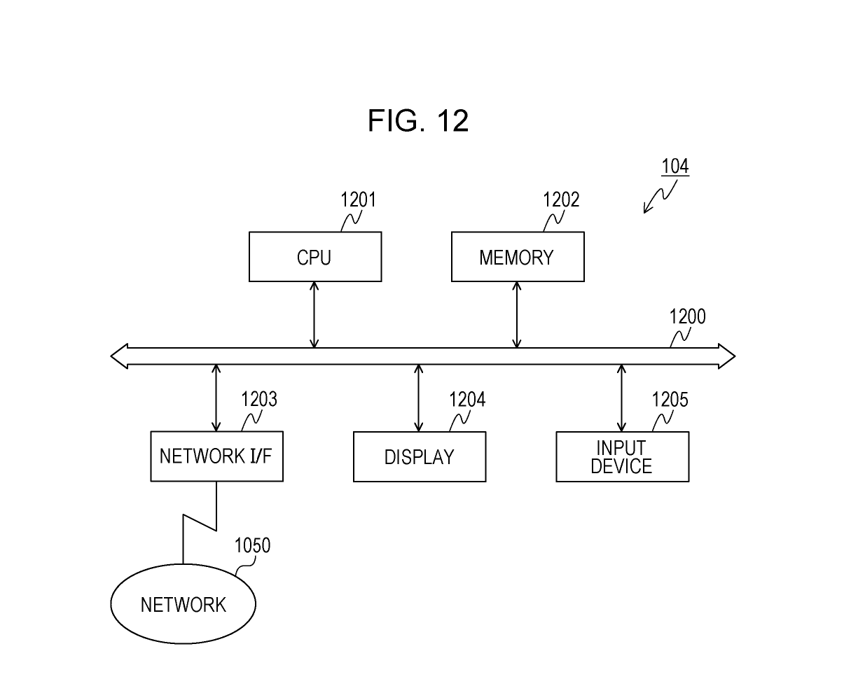

FIG. 12 is a block diagram illustrating an example hardware configuration of each terminal device. In FIG. 12, the terminal device 104 includes a CPU 1201, a memory 1202, a network I/F 1203, a display 1204, and an input device 1205. The components 1201 to 1205 are connected to each other by a bus 1200.

The CPU 1201 has control over the entire terminal device 104. The memory 1202 includes, for example, a ROM, a RAM, and a flash ROM or the like. Specifically, the flash ROM and the ROM store various programs, and the RAM is used as a work area for the CPU 1201. By being loaded to the CPU 1201, each program stored in the memory 1202 may cause the CPU 1201 to execute the corresponding coded process.

The network I/F 1203 is connected to the network 1050, such as the Internet, through a communication line and connected to another device such as the server 102 through the network 1050. The network I/F 1203 serves as an interface between the network 1050 and the inside of the terminal device 104, and controls input and output of data from and to the other device.

The display 1204 displays pieces of data such as a document, an image, a video, functional information, and so on as well as a cursor, icons, and tool boxes. For example, a liquid crystal display, an organic electroluminescence (EL) display, or the like may be employed as the display 1204. The display 1204 may be a head-mounted display. This enables reproduction of data with virtual reality.

The input device 1205 includes keys for inputting characters, numbers, various commands, and so on and inputs data. The input device 1205 may be a keyboard and pointing device or the like or a touchscreen input pad and numeric keypad or the like.

In addition to the above components, the terminal device 104 may include various sensors, a hard disk drive (HDD), a SSD, a speaker, a camera, and so on.

### Example Functional Configuration of Server 102

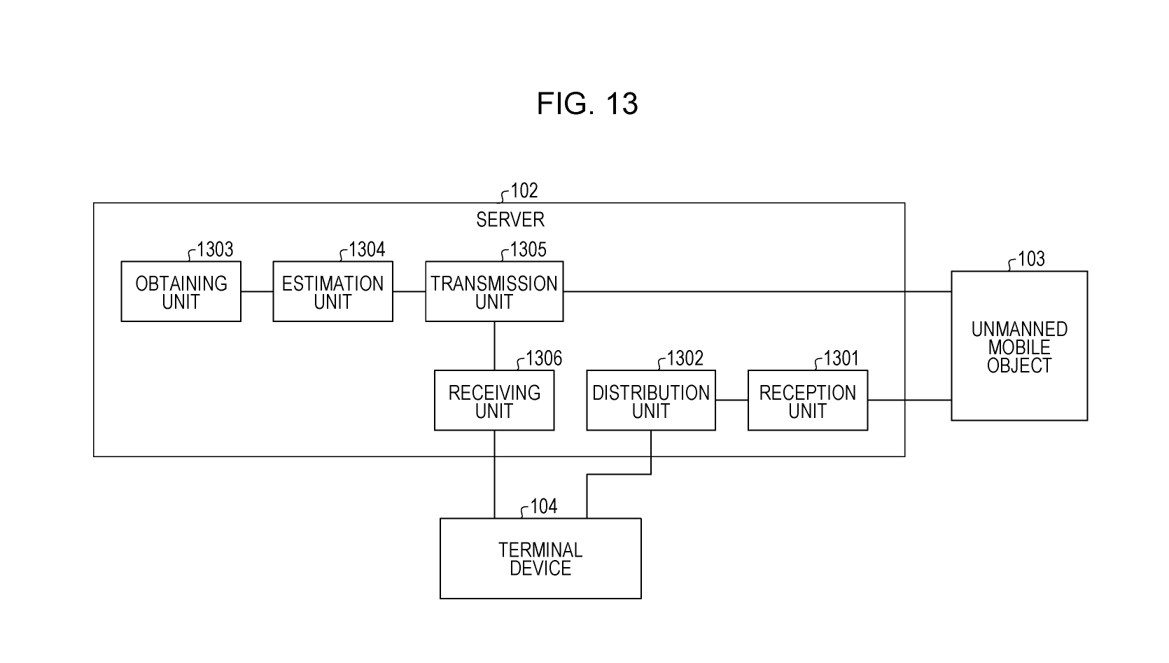

FIG. 13 is a block diagram illustrating an example functional configuration of the server. In FIG. 13, the server 102 includes a reception unit 1301, a distribution unit 1302, an obtaining unit 1303, an estimation unit 1304, a transmission unit 1305, and a receiving unit 1306. The reception unit 1301, the distribution unit 1302, the obtaining unit 1303, the estimation unit 1304, the transmission unit 1305, and the receiving unit 1306 may constitute a control unit of the server 102.

The reception unit 1301 receives captured image information transmitted from the unmanned mobile object 103. The function of the reception unit 1301 may be implemented specifically with the network I/F 1003, illustrated in FIG. 10, or the like, for example.

The distribution unit 1302 distributes the captured image information received by the reception unit 1301 to the terminal devices 104. The function of the distribution unit 1302 may be implemented specifically by causing the CPU 1001 to execute a program stored in a storage device such as the memory 1002, illustrated in FIG. 10, or with the network I/F 1003, illustrated in FIG. 10, or the like, for example.

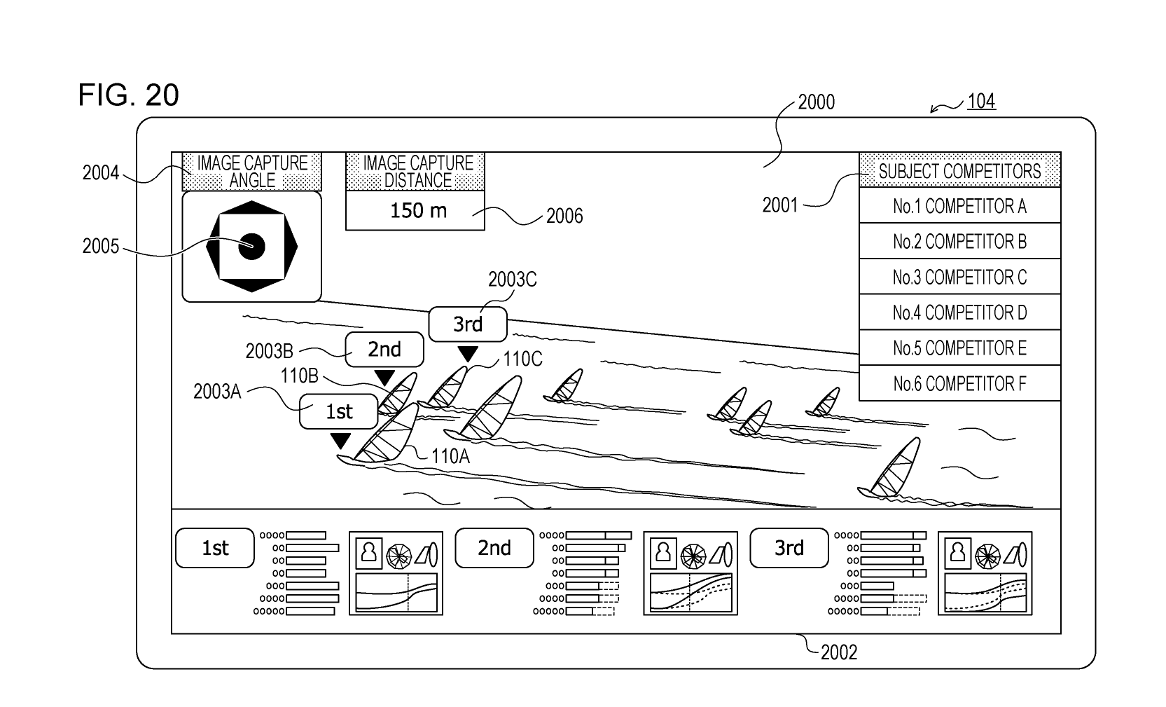

The distribution unit 1302 may distribute the received captured image as is or edit the received captured image and then distribute it. The editing information may include addition of various pieces of information such as each subject competitor's profile, current position, and so on, for example. Details of the editing information will be described with reference to FIG. 20 and so on to be discussed later.

From the sensor 101 (more specifically, a location detection sensor mounted to the rig of the sailboard 110, for example), the obtaining unit 1303 obtains the location information (such as the data on the ground speed, the direction of advance (true bearing), the latitude, and the longitude obtained from the GPS values). From the sensor 101 (more specifically, a motion sensor mounted to the rig of the sailboard 110, for example), the obtaining unit 1303 obtains the motion information (such as the data on the pitch angle, the roll angle, and the yaw angle).

The function of the obtaining unit 1303 may be implemented specifically with the network I/F 1003, illustrated in FIG. 10, or the like, for example.

The estimation unit 1304 estimates the movement direction of the sailboard 110 based on the motion information obtained by the obtaining unit 1303. The estimation unit 1304 may estimate the location of a future movement destination for the sailboard 110 based on the location information and the motion information obtained by the obtaining unit 1303.

The estimation unit 1304 may estimate the movement direction of the sailboard 110 or the location of the future movement destination for the sailboard 110 based on information on the direction of the wind in addition to the location information and the motion information. The information on the direction of the wind may be obtained, for example, from a server or database not illustrated that stores the information on the direction of the wind through the network 1050.

The estimation unit 1304 may calculate the difference between the time at which the unmanned mobile object 103 was transmitted and the current time, calculate the lag time taken to deliver the data, and estimate the movement direction of the sailboard 110 or the location of the future movement destination for the sailboard 110 with this lag time taken into account.

The function of the estimation unit 1304 may be implemented specifically by causing the CPU 1001 to execute a program stored in a storage device such as the memory 1002, illustrated in FIG. 10, for example.

As for the future movement destination, the estimation unit 1304 estimates the location of the future movement destination including in which direction the sailboard 110 will be turning to and so on (for example, estimates the location the sailboard 110 will move to in given seconds from now) based on the information on the tilt of the sail and the like in the motion information, for example.

As for the future time, the time to be taken for the unmanned mobile object 103 to reach the image capture location may be considered, for example. Assume, for example, a case where the time to be taken for the unmanned mobile object 103 to reach the image capture location is 10 seconds. In this case, 10 seconds may be set as a reference, and the location of the movement destination after around 10 seconds may be estimated. Then, based on the estimation of the location of the future movement destination, the image capture location may be corrected, and the time to be taken to reach the corrected image capture location may be used to further estimate the location of the movement destination of the unmanned mobile object 103.

This manner may ensure that the image capture device 105 of the unmanned mobile object 103 has the sailboard 110, which is a subject to capture an image of, in sight and captures its image.

The transmission unit (a unit that manages the movement of the unmanned mobile object) 1305 transmits a signal to the unmanned mobile object 103 to manage the movement of the unmanned mobile object 103. The transmission unit 1305 transmits an instruction signal specifying the movement direction of the unmanned mobile object 103 to the unmanned mobile object 103 based on the movement direction estimated by the estimation unit 1304. Alternatively, the transmission unit 1305 may transmit an instruction signal specifying the location of the movement destination for the unmanned mobile object 103 to the unmanned mobile object 103 in accordance with the location of the future movement destination estimated by the estimation unit 1304.

The function of the transmission unit 1305 may be implemented by causing the CPU 1001 to execute a program stored in a storage device such as the memory 1002, illustrated in FIG. 10, or with the network I/F 1003, illustrated in FIG. 10, or the like, for example.

The receiving unit 1306 receives a designation of an image capture location from any terminal device 104. The transmission unit 1305 transmits an instruction signal as an instruction to capture an image of the sailboard 110 at the image capture location received by the receiving unit 1306 to the unmanned mobile object 103. The function of the receiving unit 1306 may be implemented with the network I/F 1003, illustrated in FIG. 10, or the like.

The image capture location may indicate the image capture direction (image capture angle) with respect to the sailboard 110. The image capture direction with respect to the sailboard 110 may be, for example, any of the front side (for example, the front face), the rear side, the lateral side (left or right), and the top side (for example, immediately above) of the sailboard 110. In this way, the user (viewer) may view a captured image at least from any of these five viewpoints.

The image capture location may indicate the distance to the sailboard 110. Specifically, the distance is, for example, 10 m, 30 m, and so on to the sailboard. The image capture location may indicate both the image capture direction with respect to the sailboard 110 and the distance to the sailboard 110.

### Example Functional Configuration of Unmanned Mobile Object 103

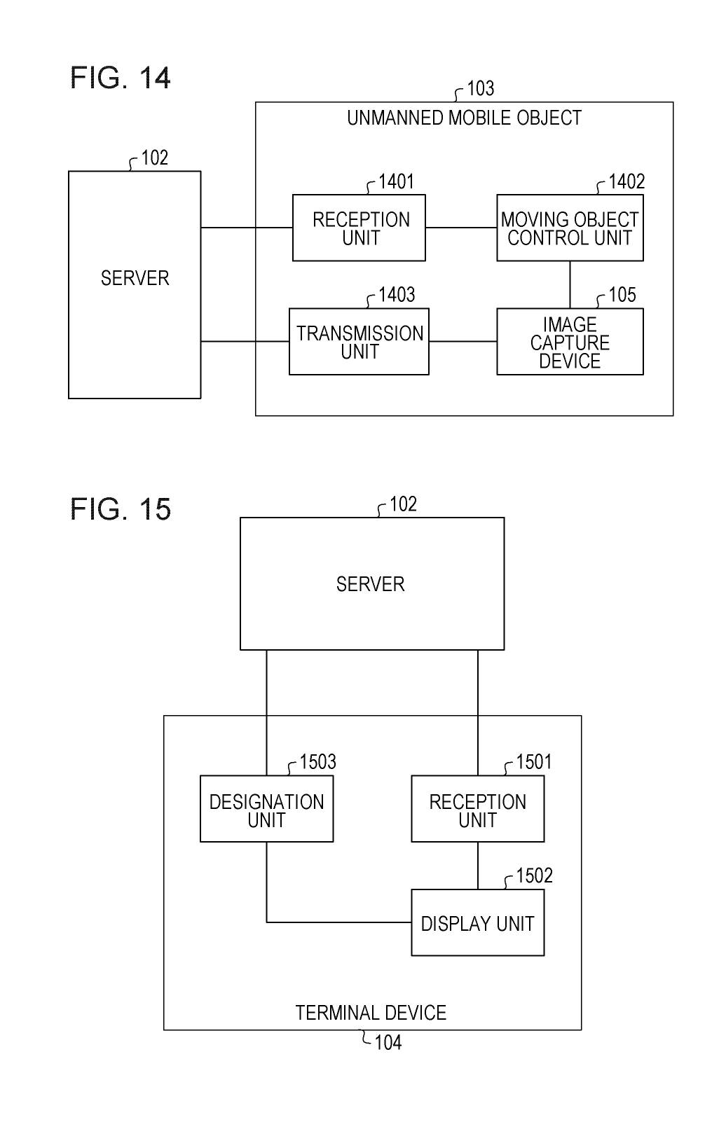

FIG. 14 is a block diagram illustrating an example functional configuration of the unmanned mobile object. In FIG. 14, the unmanned mobile object 103 includes a reception unit 1401, a moving object control unit 1402, the image capture device 105, and a transmission unit 1403. The reception unit 1401, the moving object control unit 1402, and the transmission unit 1403 may constitute a control unit of the unmanned mobile object 103.

The reception unit 1401 receives an instruction signal specifying the movement direction from the server 102. The reception unit 1401 may receive an instruction signal specifying the location of the movement destination from the server 102. The function of the reception unit 1401 may be implemented specifically with the network I/F 1104, illustrated in FIG. 11, or the like, for example.

The moving object control unit 1402 controls the movement of the unmanned mobile object 103 based on the signal received by the reception unit 1401. The function of the moving object control unit 1402 may be implemented specifically with the GPS device 1103 or the motor drive mechanism 1106 and motor 1107, illustrated in FIG. 11, or by causing the CPU 1101 to execute a program stored in a storage device such as the memory 1102, for example.

In the case where the reception unit 1401 receives an instruction signal specifying the movement direction, the moving object control unit 1402 instructs the motor drive mechanism 1106 to drive the motor 1107 so as to move in that movement direction. As a result, the unmanned mobile object 103 moves in the movement direction in the instruction signal.

In the case where the reception unit 1401 receives an instruction signal specifying the location of the movement destination, the moving object control unit 1402 calculates the movement direction and the movement distance by comparing the current location figured out from information obtained from the GPS device 1103 and the location of the movement destination in the received instruction signal. The moving object control unit 1402 instructs the motor drive mechanism 1106 to drive the motor 1107 based on the calculation result. As a result, the unmanned mobile object 103 moves to the location of the movement destination in the instruction signal.

The moving object control unit 1402 may further control the movement speed of the unmanned mobile object 103 in addition to the movement direction and the movement distance and instruct the motor drive mechanism 1106 to drive the motor 1107 based on that control. Specifically, the moving object control unit 1402 may issue an instruction to move at the maximum speed to the location of the movement destination or issue an instruction to move at 50% of the maximum speed to the location of the movement destination.

The moving object control unit 1402 may issue an instruction to change the speed along the way to the location of the movement destination. For example, the moving object control unit 1402 may issue an instruction to move at the maximum speed up to the point of 80% to the location of the movement destination and to slow down to 30% of the maximum speed in the remaining part and reach the location of the movement destination. Conversely, the moving object control unit 1402 may issue an instruction to move at a low speed first and move at a higher speed later. The speed may be changed stepwise through multiple separate steps.

In speed control as above, information on the speed control may be contained in the signal received by the reception unit 1401 from the server 102. Alternatively, the information on the speed control may not be contained in the signal received by the reception unit 1401 from the server 102 and the moving object control unit 1402 may determine based on that signal how to control the speed with the performance of the unmanned mobile object 103 and so on taken into account.

The image capture device 105 captures a moving or still image (of the sailboard 110, the rider of the sailboard 110, or an object(s) other than those). The function of the image capture device 105 may be implemented specifically with the camera 1105, illustrated in FIG. 11, or the like.

The function of the image capture device 105 may be implemented with a plurality of cameras 1105. The image capture directions of the plurality of cameras 1105 may be controlled independently of each other to capture different images (of different sailboards 110), respectively. In this way, the image capture device 105 may simultaneously capture images of different riders' riding scenes. By providing these captured images, a viewer may compare the riding actions and figure out the difference between them.

The transmission unit 1403 transmits the image information captured by the image capture device 105 to the server 102. The function of the transmission unit 1403 may be implemented specifically with the network I/F 1104, illustrated in FIG. 11, or the like.

### Example Functional Configuration of Terminal Device 104

FIG. 15 is a block diagram illustrating an example functional configuration of each terminal device 104. In FIG. 15, the terminal device 104 includes a reception unit 1501, a display unit 1502, and a designation unit 1503. The reception unit 1501, the display unit 1502, and the designation unit 1503 may constitute a control unit of the terminal device 104.

The reception unit 1501 receives a captured image (video) distributed by the server 102. The function of the reception unit 1501 may be implemented specifically with the network I/F 1203, illustrated in FIG. 12, or the like, for example.

The display unit 1502 displays the captured image received by the reception unit 1501. The function of the display unit 1502 may be implemented specifically with the display 1204, illustrated in FIG. 12, or the like, for example.

The designation unit 1503 receives a designation of an image capture location and transmits information on that designation to the server 102. The function of the designation unit 1503 may be implemented specifically with the input device 1205 and the network I/F 1203, illustrated in FIG. 12, or the like, for example. The designation with the designation unit 1503 includes, for example, designations of the image capture angle and the image capture distance or the like. Details of the designations of the image capture angle and the image capture distance or the like will be described with reference to FIG. 20 to be discussed later.

### Contents of Processes

Next, the contents of processes by the server 102, the unmanned mobile object 103, and each terminal device 104 will be described.

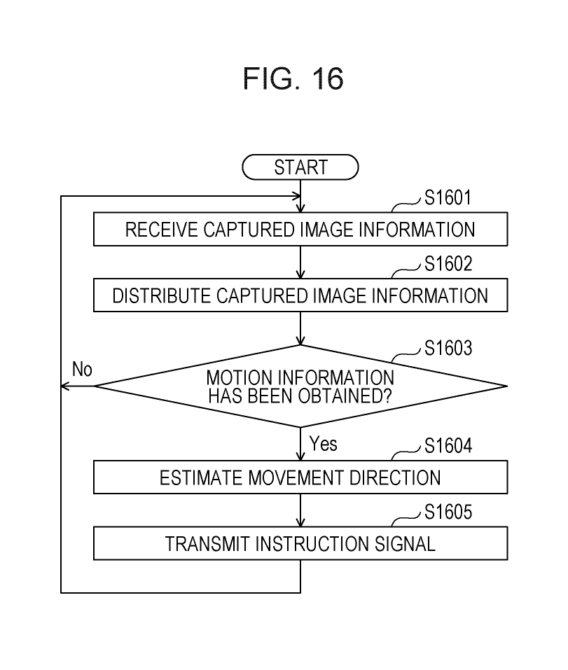

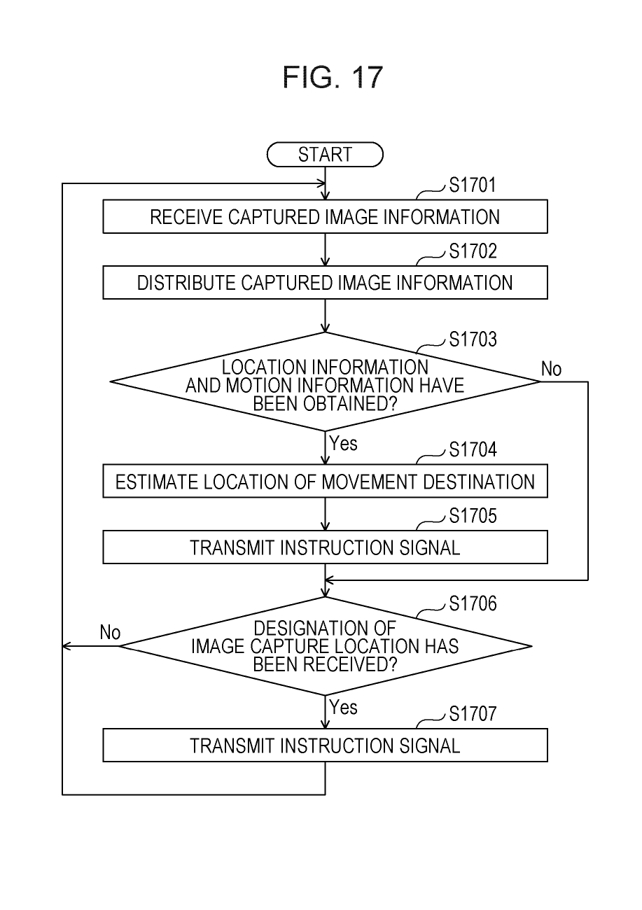

FIGS. 16 and 17 are flowcharts illustrating example procedures of a process by the server 102. In the flowchart of FIG. 16, the server 102 receives an image (captured image information) transmitted from the unmanned mobile object 103 (step S1601). In this doing so, the server 102 may additionally receive information on the unmanned mobile object 103 (for example, the location information of the unmanned mobile object 103, information of the time at which the captured image was transmitted, information of the battery, information of the presence of any failure, and so on).

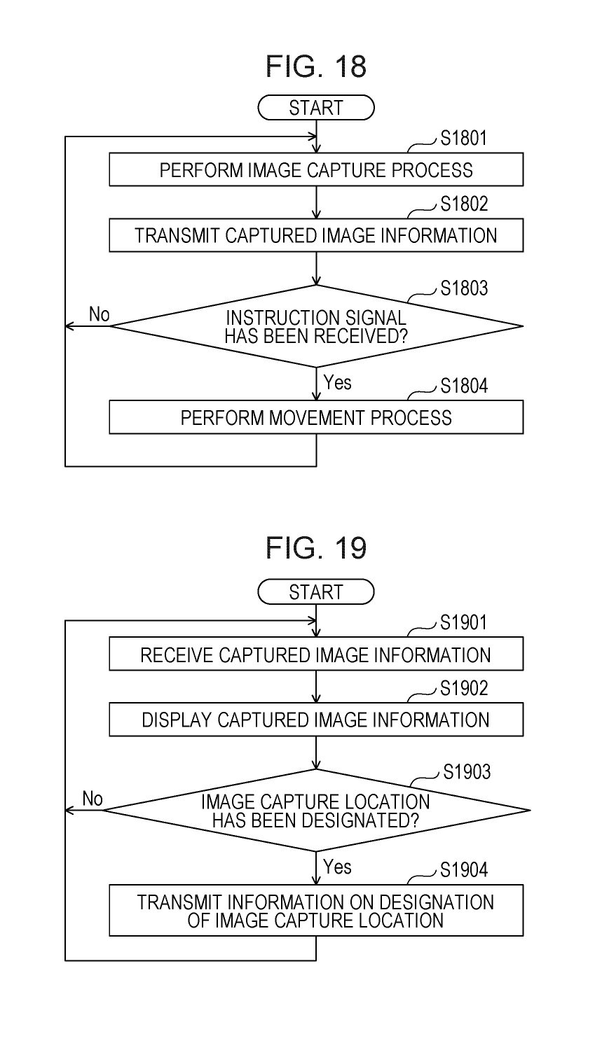

The captured image information is transmitted from the unmanned mobile object 103 in step S1802 in a flowchart in FIG. 18 to be discussed later. Then, the server 102 distributes the captured image information received in step S1601 to each terminal device 104 (step S1602).

Then, the server 102 determines whether motion information has been obtained from the sensor 101 (step S1603). If motion information has not been received (step S1603: No), the server 102 returns to step S1601 and repeats the reception of captured image information (step S1601) and the distribution of the captured image information (step S1602).

If it is determined in step S1603 that motion information has been received (step S1603: Yes), the server 102 estimates the movement direction of the sailboard 110 based on the obtained motion information (step S1604). In doing so, the server 102 may take into account the information on the unmanned mobile object 103 received from the unmanned mobile object 103 along with the captured image information.

The server 102 then transmits an instruction signal calculated based on the estimated movement direction of the sailboard 110 and specifying the movement direction of the unmanned mobile object 103 to the unmanned mobile object 103 (step S1605). In doing so, the server 102 may receive a designation of an image capture location from any terminal device 104, and transmit an instruction signal as an instruction to capture an image of the sailboard 110 at the received image capture location to the unmanned mobile object 103. This image capture location may contain information on at least one of the image capture direction with respect to the sailboard 110 and the distance to the sailboard 110.

Then, the server 102 returns to step S1601. Thereafter, the server 102 repeats the processes in steps S1601 to S1605.

FIG. 17 is a flowchart illustrating an example procedure of the process by the server 102 different from FIG. 16. In the flowchart of FIG. 17, the contents of steps S1701 and S1702 are the same as the contents of steps S1601 and S1602 in the flowchart of FIG. 16, and description thereof is therefore omitted.

In step S1703, the server 102 determines whether location information and motion information have been obtained from the sensor 101 (step S1703). If location information and motion information have not been received (step S1703: No), the server 102 proceeds to step S1706.

On the other hand, if it is determined in step S1703 that location information and motion information have been obtained (step S1703: Yes), the server 102 estimates the location of the future movement destination for the sailboard 110 based on the obtained location information and motion information (step S1704). Then, the server 102 transmits an instruction signal specifying the location of the movement destination for the unmanned mobile object 103 to the unmanned mobile object 103 in accordance with the estimated location of the future movement destination for the sailboard 110 (step S1705), and proceeds to step S1706.

In step S1706, the server 102 determines whether a designation of an image capture location has been received from any terminal device 104 (step S1706). The designation of an image capture location is transmitted from the unmanned mobile object 103 in step S1904 in a flowchart in FIG. 19 to be discussed later. If there is no designation of an image capture location (step S1706: No), the server 102 does nothing and returns to step S1701.

On the other hand, if it is determined in step S1706 that there is a designation of an image capture location (step S1706: Yes), the server 102 transmits an instruction signal based on that designation to the unmanned mobile object 103 (step S1707). Specifically, that instruction signal may be an instruction signal as an instruction to capture an image of the sailboard 110 at the image capture location in the received designation, for example. Then, the server 102 returns to step S1701. Thereafter, the server 102 repeats the processes in steps S1701 to S1707.

As described above, the server 102 may execute either the process in the flowchart of FIG. 16 or the process in the flowchart of FIG. 17.

Next, the content of a process by the unmanned mobile object 103 will be described. FIG. 18 is a flowchart illustrating an example procedure of the process by the unmanned mobile object 103. In the flowchart of FIG. 18, the unmanned mobile object 103 executes an image capture process (step S1801). Specifically, the unmanned mobile object 103 captures an image with the image capture device 105 continuously.

Then, the unmanned mobile object 103 transmits the captured image (captured image information) to the server 102 (step S1802) continuously. In doing so, the unmanned mobile object 103 may additionally transmit the information on the unmanned mobile object 103 (for example, the location information on the unmanned mobile object 103, the information on the time at which the captured image was transmitted, the information on the battery, the information on the presence of any failure, and so on).

Then, the unmanned mobile object 103 determines whether an instruction signal transmitted from the server 102 has been received (step S1803). The instruction signal is transmitted from the server 102 in step S1605 in the flowchart of FIG. 16 or in step S1705 or S1707 in the flowchart of FIG. 17.

If it is determined in step S1803 that no instruction signal has been received (step S1803: No), the unmanned mobile object 103 returns to step S1801 and repeats the image capture process (step S1801) and the transmission of the captured image information (step S1802).

On the other hand, if it is determined in step S1803 that an instruction signal has been received (step S1803: Yes), the unmanned mobile object 103 executes a process based on the received instruction signal to move in the movement direction or to the movement location specified in the instruction signal (step S1804). Then, the unmanned mobile object 103 returns to step S1801. Thereafter, the unmanned mobile object 103 repeats the processes in steps S1801 to S1804.

Next, the content of a process by each terminal device 104 will be described. FIG. 19 is a flowchart illustrating an example procedure of the process by the terminal device 104. In the flowchart of FIG. 19, the terminal device 104 receives an image (captured image information) distributed from the server 102 (step S1901).

The captured image information is distributed from the server 102 in step S1602 in the flowchart of FIG. 16 or in step S1702 in the flowchart of FIG. 17. Then, the terminal device 104 displays the captured image information received in step S1901 (step S1902).

Then, the terminal device 104 determines whether an image capture location has been designated by the user (step S1903). Specifically, whether an image capture location has been designated may be determined based on, for example, whether a touch on the touchscreen of the display 1204, illustrated in FIG. 12, by the user has been detected.

If it is determined in step S1903 that no image capture location has been designated (step S1903: No), the terminal device 104 returns to step S1901 and repeats the reception of captured image information (step S1901) and the display of the captured image information (step S1902).

On the other hand, if it is determined in step S1903 that an image capture location has been designated (step S1903: Yes), the terminal device 104 transmits information on the designation of the image capture location to the server 102 (step S1904). Then, the terminal device 104 returns to step S1901. Thereafter, the terminal device 104 repeats the processes in steps S1901 to S1904.

### Content of Display Windows on Terminal Device

Next, an overview of display windows on a terminal device 104 will be described. FIGS. 20, 21, and 23 are explanatory diagrams illustrating an example of display windows on the terminal device. In FIG. 20, a display window 2000 on the terminal device 104 displays an image (video) distributed from the server 102. In the image, a scene of a windsurfing race currently being held is streamed live.

In FIG. 20, a list 2001 of subject competitors is displayed on the upper right side of the display window 2000. The subject competitors' numbers (No. 1 to No. 6) and names or the like are displayed.

Under the display window 2000 is displayed a display window 2002 which displays the current positions of competitors in top positions (the “1st (first position)”, “2nd (second position)”, and “3rd (third position)” competitors) in the race and their profiles and various pieces of data. In conjunction with this information, a pop-up window 2003A with “1st” is displayed on the display window 2000 by a windsurfing board 110A in the first position. Likewise, a pop-up window 200B with “2nd” is displayed by a windsurfing board 110B in the second position, and a pop-up window 2003C with “3rd” is displayed by a windsurfing board 110C in the third position.

Such display allows the viewer to see competitors' positions in the video in conjunction with their profiles, various pieces of data, and so on and thus enjoy watching the race to a greater extent.

On the upper left side of the display window 2000 is displayed an “image capture angle” window 2004. The image capture angle may be changed just like using a joystick by touching a black circle area 2005 in the center of the “image capture angle” window 2004 with a finger or the like and moving the finger or the like upward, downward, rightward, or leftward while keeping it in the touching state.

The image capture angle may be changed either by changing the location of the unmanned mobile object 103 or by changing the image capture direction of the image capture device 105, mounted to the unmanned mobile object 103. Then, the unmanned mobile object 103 or the image capture device 105, mounted to the unmanned mobile object 103, may be operated by operating the center black circle area 2005 just like using a joystick.

To the right of the “image capture angle” window 2004 is displayed an “image capture distance” window 2006. In the “image capture distance” window 2006, the distance from the unmanned mobile object 103 to the subject (windsurfing board 110) (150 m) is displayed. The image capture distance may be changed by touching the “image capture distance” window 2006 with a finger or the like, which displays a distance level bar not illustrated, and adjusting this level bar. Alternatively, a numeric keypad not illustrated may be displayed in response to touching the “image capture distance” window 2006 with a finger or the like, and the numerical value of an image capture distance may be directly entered with the numeric keypad.

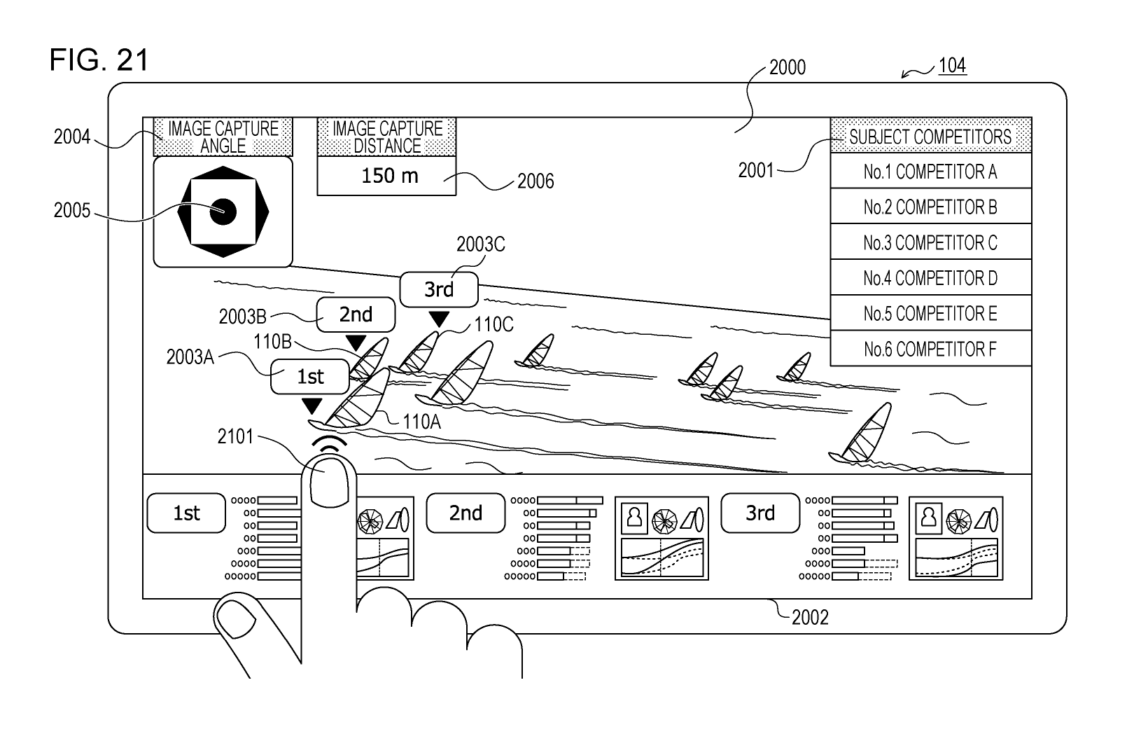

FIG. 21 illustrates a state where the windsurfing board 110A in the first position in the display window 2000 on the terminal device 104 is directly tapped with a finger 2101. This represents an instruction (designation) to “move the unmanned mobile object 103 to the vicinity of the windsurfing board 110A in the first position since the viewer desires to see a closeup of the windsurfing board 110A in the first position”.

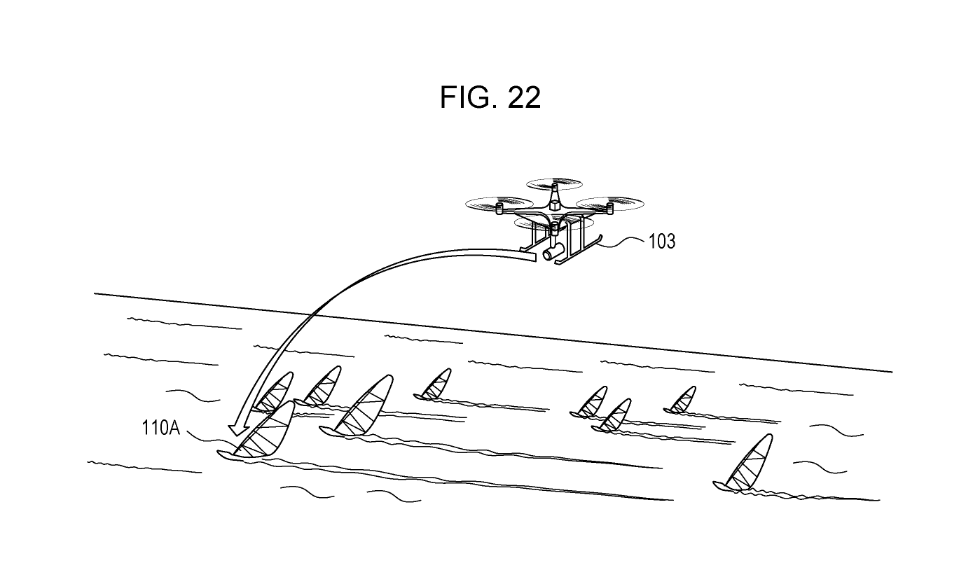

FIG. 22 is an explanatory diagram illustrating an overview of control of the unmanned mobile object. In response to a designation of an image capture location as illustrated in FIG. 21, the unmanned mobile object 103 at a distance of 150 m to the subject moves to the vicinity of the windsurfing board 110A in the first position.

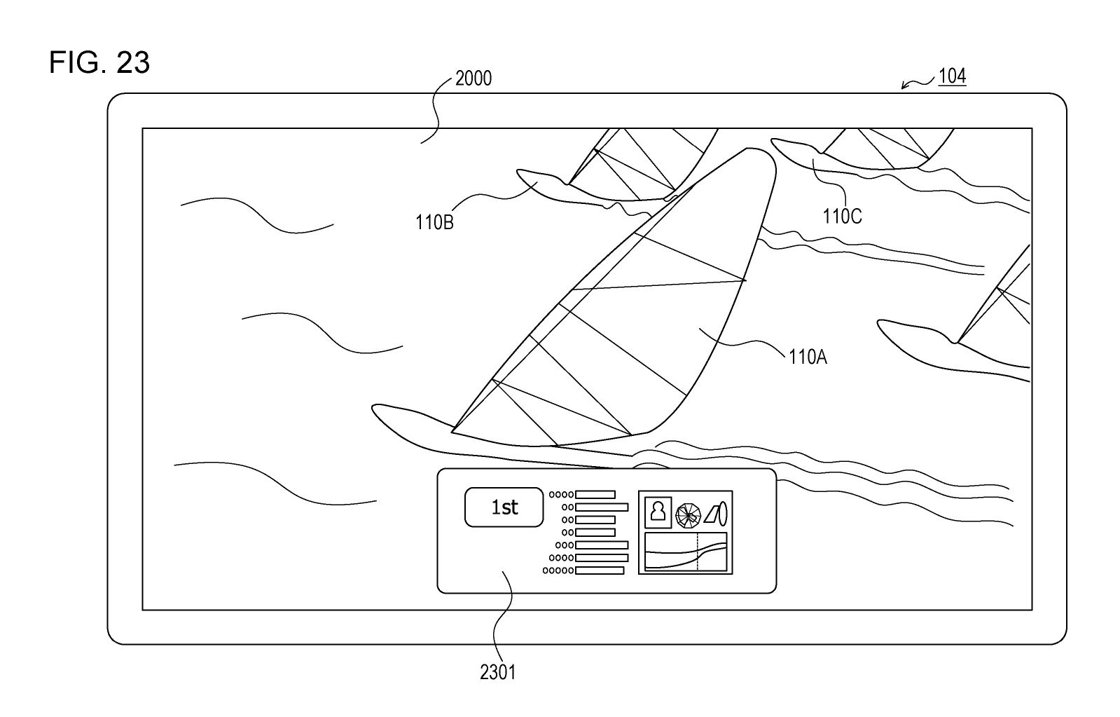

The unmanned mobile object 103 thus moving completes the movement and then captures a video, and the server 102 distributes the video, which is the video illustrated in FIG. 23. In the display window 2000 in FIG. 23, the windsurfing board 110A in the first position is displayed enlarged in the center of the display window 2000. On the lower side of the display window 2000, only a display window 2301 is displayed which displays the “1st (first position)” competitor's profile and various pieces of data.

Thus, by designating a desired windsurfing board 110, a closeup of that windsurfing board 110 may be displayed. Thereafter, by, for example, further tapping the display window 2000, the video may be put back to the original one, that is, the unmanned mobile object 103 may be instructed to move to the location where the original video may be captured.

Although not illustrated, in the case where a plurality of windsurfing boards 110 are designated at the same time, the unmanned mobile object 103 may be moved to a location where all of them may be displayed, and capture a closeup video of the plurality of windsurfing boards 110.

As described above, the user of each terminal device 104 may not only watch a scene of a race on the display window 2000 on the terminal device 104 but also freely change the image capture location. In this way, the video that the user desires to watch may be provided in real time.

The number of unmanned mobile objects 103 may be increased to provide videos satisfying the demands of a greater number of users. In this case, instead of simply moving the unmanned mobile objects 103 in accordance with the users' instructions, the plurality of unmanned mobile objects 103 may be caused to operate in conjunction with each other and the images captured by them may be switched from one to another to provide images (videos) the respective users desire.

As described above, in the embodiment, the movement direction of a sailboard 110 is estimated based on the motion information obtained from the motion sensor mounted to the rig of the sailboard 110 and an instruction signal specifying the movement direction of the unmanned mobile object 103, to which the image capture device 105 is mounted, is transmitted to the unmanned mobile object 103 based on the estimated movement direction.

Thus, the motion sensor mounted to the sailboard 110, which detects the motion of the sailboard 110, may be used to detect the motion of the sailboard 110 and predict a next possible event, and the movement direction of the unmanned mobile object 103 may be determined based on that prediction. In this way, an image may be captured from the optimal camera angle.

According to the embodiment, the motion information may be motion information on the mast 111 or the boom 114 of the rig. By using the motion information on the mast 111 or the boom 114 of the rig, a next possible event with the sailboard 110 may be predicted more reliably.

According to the embodiment, the movement direction of the sailboard 110 may be estimated based on the motion information and the information on the wind. In this way, the movement direction of the sailboard 110 may be estimated more accurately.

According to the embodiment, a designation of an image capture location may be received, and an instruction signal as an instruction to capture an image of the sailboard 110 at the received image capture location may be transmitted to the unmanned mobile object 103. The image capture location may contain information on at least one of the image capture direction with respect to the sailboard 110 and the distance to the sailboard. In this way, an image captured from a desired image capture location (image capture angle) may be provided.

According to the embodiment, the location of the future movement destination for the sailboard 110 is estimated based on the location information obtained from the location detection sensor mounted to the sailboard 110 and the motion information obtained from the motion sensor mounted to the rig of the sailboard 110 and an instruction signal specifying the location of the movement destination for the unmanned mobile object 103, to which the image capture device 105 is mounted, is transmitted to the unmanned mobile object 103 based on the estimated location of the future movement destination.

Thus, the location detection sensor and the motion sensor mounted to the sailboard 110, which detect the location and the motion of the sailboard 110, may be used to detect the location and the motion of the sailboard 110 and predict a next possible event, and location of the movement destination for the unmanned mobile object 103 may be determined based on that prediction. In this way, an image may be captured from the optimal camera angle.

According to the embodiment, the location of the future movement destination for the sailboard 110 may be estimated based on the location information, the motion information, and the information on the wind. In this way, the future movement location for the sailboard 110 may be estimated accurately.

A designation of an image capture location may be received, and an instruction signal as an instruction to capture an image of the sailboard 110 at the received image capture location may be transmitted to the unmanned mobile object 103. The image capture location may contain information on at least one of the image capture direction with respect to the sailboard 110 and the distance to the sailboard. In this way, an image captured from a desired image capture location (image capture angle) may be provided.

The unmanned mobile object 103 may be an unmanned aerial vehicle or an unmanned watercraft. By using an unmanned aerial vehicle, images (videos) captured from various angles from above may be obtained. By using an unmanned watercraft, an image (video) captured from an angle at a position close to the water surface may be obtained.

The above features enable the viewer to see how the sailboard 110 travels more accurately and also from various directions. This improves the quality of images captured by the unmanned mobile object, equipped with an image capture device.

Accordingly, the viewer may enjoy watching the race. In addition, the viewer may visually check the speed, the direction of advance, the state of travel, and in particular how the sailing is done, and check the form. Doing so may help to make the optimal form. Thus, the above features may help to achieve efficient riding and travel and hence improve the windsurfing board riding technique.

This embodiment has been described using windsurfing boards as moving objects that move with the force of the wind. However, the moving objects are not limited to windsurfing boards but may be ones that sail such as yachts, for example. The moving objects are not limited to moving objects that sail on the water but may be ones that sail on the ground.

The control method described in this embodiment may be implemented by executing a program prepared in advance on a computer such as a personal computer or a work station. The control program is stored in a computer-readable recording medium such as a hard disk drive, a flexible disk, a compact disc (CD)-ROM, a magneto-optical disk (MO), a digital versatile disk (DVD), or a Universal Serial Bus (USB) memory, and is read out of the recording medium and executed by a computer. Alternatively, the control program may be distributed through a network such as the Internet. At least one “CPU” may be called a “processor”.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing therein a control program for causing a computer to execute a process, the process comprising:
estimating a movement direction of a movable body based on motion information obtained from a motion sensor mounted on the movable body; and
transmitting a signal specifying a movement direction of an unmanned mobile object to which an image capture device is mounted to the unmanned mobile object based on the estimated movement direction.

2. The non-transitory computer-readable recording medium according to claim 1, wherein the movable body is a sailboard, and the motion information is motion information on a mast or a boom of the sailboard.

3. The non-transitory computer-readable recording medium according to claim 1, wherein the estimating a movement direction is performed based on the motion information and information on a direction of wind.

4. The non-transitory computer-readable recording medium according to claim 1, further comprising:
receiving a designation of an image capture location; and
transmitting a signal as an instruction to capture an image of the movable body at the received image capture location to the unmanned mobile object.

5. The non-transitory computer-readable recording medium according to claim 4, wherein the image capture location includes information on at least one of an image capture direction with respect to the movable body and a distance to the movable body.

6. A control device comprising:
a memory; and
a processor coupled to the memory and the processor that
executes a process comprising
estimating a location of a future movement destination for a sailboard based on location information obtained from a location detection sensor mounted to the sailboard and motion information obtained from a motion sensor mounted to a rig of the sailboard; and
transmitting a signal specifying a location of a movement destination for an unmanned mobile object to which an image sensor is mounted to the unmanned mobile object in accordance with the estimated location of the future movement destination.

7. A method for tracking an object in motion, comprising:
receiving initial image information captured by an image capturing device located on a mobile vehicle;
receiving motion information relating to a movement of an object from a first sensor located on the object;
estimating a movement direction of the object based on the received motion information relating to the movement of the object;
receiving a designation of an image capture location;
transmitting a signal to the mobile vehicle specifying a movement direction of the mobile vehicle based on the estimated movement direction of the object and the designation of the image capture location, to instruct the image capturing device on the mobile vehicle to capture an image of the object at the image capture location as additional image information; and
transmitting both the initial image information and the additional image information to track the object.
